(19) United States
(12) Patent Application Publication
(10) Pub. No.: US 2009/0064226 A1
(43) Pub. Date: Mar. 5, 2009

(54) USER INTERFACE OF INTERACTIVE PROGRAM GUIDE AND METHOD THEREOF

(75) Inventors: Chi Chia Lin, Tainan County (TW); Ching Kwei Hsu, Tainan County (TW); Chun Sung Chou, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/847,123

(22) Filed: Aug. 29, 2007

(51) Int. Cl. G06F 3/00

(52) U.S. Cl. 725/40

(57) ABSTRACT

A user interface of an interactive program guide includes a two-dimensional EPG area and a selected program area. The two-dimensional EPG area includes a list of channels, programs corresponding to the channels and an indicator pointing to a selected program. The selected program area includes an analog clock indicating the current time and display period of the selected program and a status area with text indicating the status of the selected program.

### BACKGROUND OF THE INVENTION

1. Field of the Invention

The present invention relates to an interactive program guide, and more particularly to a user interface of an interactive program guide and the method thereof.

2. Description of the Related Art

Digital TV (DTV) is becoming more and more popular throughout the world. In a DTV environment, the program guide is transmitted in a digital manner through a variety of channels. When a user turns on a DTV, the first thing he or she looks at is inevitably an electronic program guide (EPG). Through the EPG, it is easier for the user to understand program content, and thus select the operations he or she needs, such as pre-recording, searching, scheduling and setting up personal preferences.

Despite the advantages of EPGs, current products still have many disadvantages. For example, for some grid-based two-dimensional (2D) user interfaces for EPG, there are fixed time slots, such as thirty minutes, used to align all the programs in the EPG. However, if some programs in EPG have a starting time that does not align to the time slot of the EPG, the EPG still uses an inconsistent starting time to represent those programs, and thus the display time of those programs do not reflect their reality in the EPG. Furthermore, if a program is so lengthy that it has to occupy a couple of time slots, the viewer can not solely click a rightward button to move the indicator from that program to its right-handed side adjacent program, but rather must click the rightward button by the same times as the number of time slots it occupies. In addition, the program slots in EPG are too small to exhibit necessary information of those programs, and it is not easy for the viewer to understand when the program is showing at his or her first glance.

Because the friendly user interface is necessary to meet user demands, it is important to design a cost effective method to solve such an issue.

### SUMMARY OF THE INVENTION

The user interface of an interactive program guide in accordance with an embodiment of the present invention comprises a two-dimensional EPG area and a selected program area. The two-dimensional EPG area includes a list of channels, programs corresponding to the channels and an indicator pointing to a selected program. The selected program area includes an analog clock indicating the current time and display period of the selected program and a status area with text indicating the status of the selected program.

The user interface of an interactive program guide in accordance with an embodiment of the present invention comprises a two-dimensional EPG area and a separate selected program area. The two-dimensional EPG area includes a list of channels, programs corresponding to the channels and an indicator pointing to a selected program. The separate selected program area includes means for indicating the current time and display period of the selected program and a means for indicating the status of the selected program.

The method for using a user interface of an interactive program guide in accordance with an embodiment of the present invention comprises the steps of: displaying a two-dimensional EPG, wherein the EPG has a list of channels and programs corresponding to the channels; displaying an analog clock which indicates the current time and display period of the selected program pointed by an indicator; and displaying text indicating the status of the selected program.

### BRIEF DESCRIPTION OF THE DRAWINGS

The invention will be described according to the appended drawings in which:

FIG. 1 shows a user interface of a two-dimensional interactive program guide in accordance with an embodiment of the present invention; and

FIG. 2 shows another user interface after the indicator changes position in accordance with an embodiment of the present invention.

### PREFERRED EMBODIMENT OF THE PRESENT INVENTION

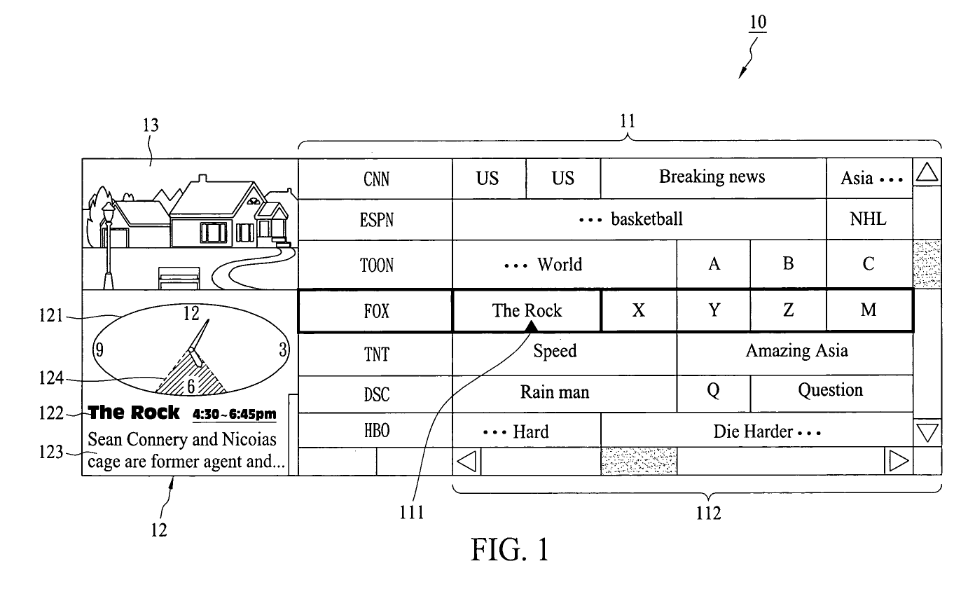

FIG. 1 shows a user interface of a two-dimensional interactive program guide in accordance with an embodiment of the present invention. A user interface 10 includes an EPG area 11, a selected program area 12 and a preview area 13. The EPG area 11 may be embodied in a box structure. The leftmost side shows the name of program providers or channels, such as CNN, ESPN, TOON, FOX, TNT, DSC and HBO. The display time frame 112 is fixed, e.g., 6 hours. The boxes represent media programs, which could be television programs, radio programs, streaming audio programs or streaming video programs. Also, each box is proportional in length to the running time of the program. Compared with the prior art, any program of the embodiment of the present invention occupies a single box of the EPG. Therefore, the viewer can simply click a single rightward button to move an indicator to the right-handed box of the EPG, no matter how lengthy the program is. It is important to note that the EPG area 11 does not have a time axis on the top of the EPG area 11 like many prior arts do. The present invention moves the timing function to the selected program area 12. The selected program area 12 has an analog clock 121, a status area 122 and a synopsis area 123 for the selected program. The analog clock 121 shows the current time with minute and hour pointers. There is a highlighted region 124, which represents the display period of the selected program, shown on the analog clock 121. The highlighted region 124 could be expressed with a specific color or texture. The status area 122 shows the full name of the selected program and the display period of that selected program. The synopsis area 123, which could be provided by a program header, gives a brief description of the selected program. By means of the selected program area 12, the viewer can clearly realize the status of that selected program at his or her first glance without taking any further action. The preview area 13, which could be a representative picture or a piece of a preview video, is optional. With the preview area 13, it is easier for the viewer to understand the content of the selected program.

There is an indicator 111 with variable color or texture in the EPG area 11. For example, if the indicator 111 points to the program “The Rock,” a bold square encloses programs on channel “FOX” on which the selected program is shown. And a specific color, probably green, indicates the box of that selected program. Therefore, the viewer can realize the location of the selected program. The indicator 111 can be triangle-shaped and maintained in a fixed size. It is commonly seen that the number of the channels and the programs may be so large that the EPG cannot accommodate those channels and programs in a single screen. To solve such issue, the embodiment designs scrolling bars on the right-hand side and bottom of the EPG area 11. Accordingly, the viewer can realize the relating location that the selected program corresponds to the entire EPG, and change the portions he or she wants to view by means of the scrolling bars.

Even though the starting time of the EPG is based on the selected program which is highlighted by the indicator, there may be other adjacent programs which have a starting time earlier than the selected program. For example, in FIG. 1 the selected program “The Rock” has a starting time of 4:30 p.m., but an adjacent program “World” on channel “TOON” has a starting time of 4:15 p.m. For expressing the different starting time, the embodiment uses symbol “ . . . ” to represent that the starting time of program “World” is earlier than the selected program. A similar situation happens with the program “basketball” on channel “ESPN,” and the program “Hard” on channel “HBO.” Another situation happens in the rear programs of the EPG. If the ending time of adjacent programs is later than the selected program, the symbol “ . . . ” is also applied. For example, the program “Asia” on channel “CNN” and the program “Die Harder” on channel “HBO.”

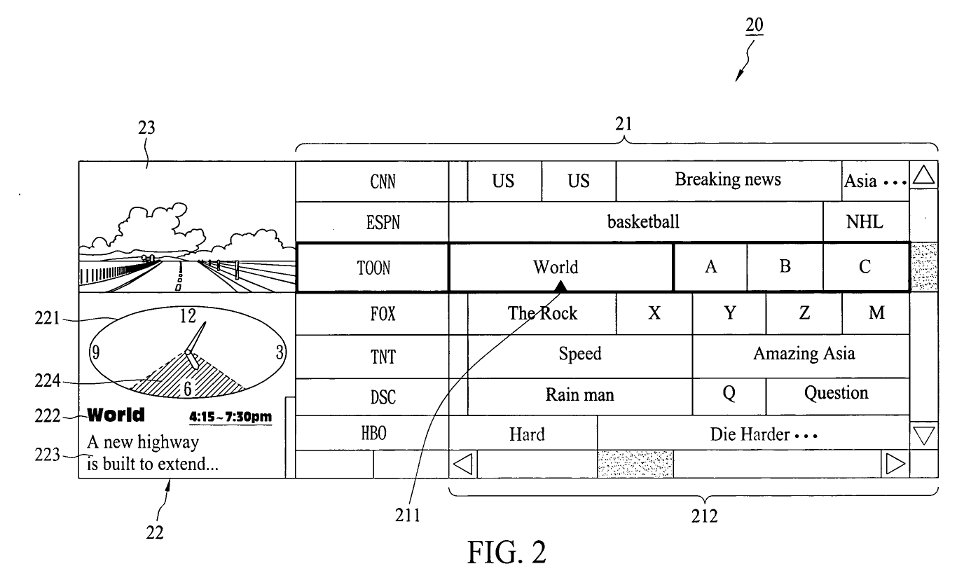

FIG. 2 shows another user interface 20 after the indicator changes position. If the viewer moves the indicator to the program “World” on channel “TOON,” the bold square encloses the channel “TOON” and a green color indicates the box of the program “World” instead. Specially, because the starting time of the program “World” is earlier than that of the previous selected program “The Rock” for making a new alignment based on the program “World,” the boxes of channels “CNN,” “FOX,” “TNT,” “DSC” move rightward by a proportional length of fifteen minutes. Because the display time frame 212 is fixed, some boxes may disappear on the screen after being moved rightward. If the programs “basketball” and “Hard” have a starting time of 4:15 p.m. as well, the preceding symbol “ . . . ” is thus removed. A rule regarding rightward movement of the EPG may be defined that if the starting time of the newly selected program is earlier than the previously selected program, the EPG screen makes a rightward movement so that the starting time of the new EPG screen is in alignment with that of the newly selected program; but if the starting time of the newly selected program is later than the previously selected program, the EPG screen need not make a rightward movement. The above definition is just an example, and persons skilled in the art could define this in his or her unique way.

In the meantime, the analog clock 221 of the selected program area 22 changes its highlighted region to 4:15-7:30 p.m., the status area 222 changes the name of the selected program as well as its display period, and the synopsis area 223 changes to a brief description for the newly selected program. Also, the preview area 23 changes to a representative picture or a piece of a preview video for the newly selected program.

The above-described embodiments of the present invention are intended to be illustrative only. Numerous alternative embodiments may be devised by persons skilled in the art without departing from the scope of the following claims.

What is claimed is:

1. A user interface of an interactive program guide, comprising:
a two-dimensional electronic program guide (EPG) area having:
a list of channels;
programs corresponding to the channels; and
an indicator pointing to a selected program; and
a selected program area having:
an analog clock indicating the current time and display period of the selected program; and
a status area with text indicating the status of the selected program.

2. The user interface of claim 1, wherein each program occupies a single box of the two-dimensional EPG area.

3. The user interface of claim 1, wherein the selected program area further comprises a synopsis area which has a brief description of the selected program.

4. The user interface of claim 1, wherein the display period of the selected program in the analog clock is shown with a color or texture.

5. The user interface of claim 1, wherein the status area describes in text the name and the display time of the selected program.

6. The user interface of claim 1, wherein the display time frame of the EPG is fixed.

7. The user interface of claim 1, further comprising a preview area which indicates a representative picture or a piece of preview video of the selected program.

8. The user interface of claim 1, further comprising a bold square which encloses programs of a channel on which the selected program is presented.

9. The user interface of claim 1, wherein the indicator is triangle-shaped and maintained in a fixed size.

10. The user interface of claim 1, further comprising two scrolling bars on the right side and bottom of the two-dimensional EPG area.

11. The user interface of claim 1, wherein the box of a program in the two-dimensional EPG area contains a specific symbol if the program has a starting time earlier or an ending time later than the selected program.

12. A user interface of an interactive program guide, comprising:
a two-dimensional EPG area having a list of channels, programs corresponding to the channels and an indicator pointing to a selected program; and
a separate selected program area having:
means for indicating the current time and display period of the selected program; and
means for displaying text indicating the status of the selected program.

13. The user interface of claim 12, wherein the display period of the selected program is shown with a color or texture.

14. The user interface of claim 12, wherein the status of the selected program includes the name and the display time of the selected program.

15. A method for using a user interface of an interactive program guide, comprising the steps of:
displaying a two-dimensional EPG, wherein the EPG has a list of channels and programs corresponding to the channels;
displaying an analog clock which indicates the current time and display period of the selected program pointed by an indicator; and
displaying text indicating the status of the selected program.

16. The method of claim 15, further comprising the step of enclosing programs of a channel on which the selected program is shown with a bold square and filling the selected program with a color or texture.

17. The method of claim 15, further comprising the step of adjusting the starting time of the two-dimensional EPG if the starting time of a newly selected program is earlier than a previously selected program.

18. The method of claim 15, further comprising the step of leaving the starting time of the two-dimensional EPG unchanged if the starting time of a newly selected program is later than a previously selected program.

19. The method of claim 15, further comprising the step of displaying a piece of preview video or a representative picture of the selected program.

20. The method of claim 15, further comprising the step of displaying a synopsis of the selected program.
